(19) United States
(12) Patent Application Publication
(10) Pub. No.: US 2018/0353799 A1
(43) Pub. Date: Dec. 13, 2018

(54) PRINTING METHOD FOR AN ELASTOMERIC LAYER AND ARTICLE THEREFROM

(71) Applicant: MPD Holdings, Inc., Cerritos, CA (US)

(72) Inventors: Glenn M. Boghosian, Cerritos, CA (US); Chen Ju Lai, Chaiyi County (TW); Chen I Kao, Chang Hwa (TW)

(73) Assignee: MPD Holdings, Inc., Cerritos, CA (US)

(21) Appl. No.: 15/618,012

(22) Filed: Jun. 8, 2017

(51) Int. Cl. A63B 21/00; B41M 5/385; B32B 5/02; B32B 25/10; B32B 25/08; B32B 5/18; B32B 25/04; A47G 27/02

(52) U.S. Cl. CPC A63B 21/4037; B41M 5/385; B32B 5/028; B32B 25/10; A47G 27/0243; B32B 5/18; B32B 25/045; A47G 27/0212; B32B 2255/10; B32B 25/08

(57) ABSTRACT

A method of printing on elastomer material and related article is provided, resulting in an epoxidized elastomeric (EEM) layer having a color image retained with high color density, high colorfastness, and low color migration, resulting in an image capable of rendering and maintaining sharp detail. The EEM layer is configured to be receptive of and to retain color dye(s), e.g., particularly via sublimation. To that end, the EEM layer has an epoxidized elastomeric material, compounded of an elastomer and an epoxy of a prescribed amount.

### FIELD OF THE INVENTION

The present invention relates generally to methods for applying an image on an elastomeric layer and articles therefrom and, more particularly.

### BACKGROUND OF THE INVENTION

Various solutions exist for depicting images on elastomer material. However, in many instances tradeoffs exist between functionality and aesthetics. Some of the current solutions include silk-screen and UV lithography printing. These solutions involve the direct transfer of ink or pigment onto the surface of a elastomer. These approaches are generally effective for applications that do not have significant functionality requirements. Another solution in the field has been sublimation printing onto elastomers. However, current sublimation printing approaches are only effective on a small subset of elastomers, and color tends to migrate and bleed throughout the material, resulting in images having a faded unsharpened appearance, therefore rendering this solution ineffective in applications requiring fine detail.

For example, for elastomer mats, such as yoga mats, there is a desire to produce yoga mats stylized with color and design, which still address necessary functional concerns, such as having a non-slip surface and colorfastness. However, current methods can cause a mat to be slippery, compromising a necessary functional consideration. .

Therefore, it must be appreciated there remains the need for a method of printing on elastomeric layers with colors or designs without compromising functionality.

### SUMMARY OF THE INVENTION

Briefly, and in general terms, a method of printing on elastomer material is provided, resulting in an epoxidized elastomeric (EEM) layer having a color image retained with, high colorfastness and low color migration, resulting in an image capable of sharp detail and or saturation. The EEM layer is configured to be receptive of and to retain color dye(s), e.g., particularly via sublimation. To that end, the EEM layer can be an epoxidized elastomeric material or a , compounded elastomer with a prescribed amount of epoxy contained within

More specifically, in an exemplary embodiment, the EEM layer is compounded with an elastomer and an epoxy of at least 10 PHR, and preferably between 40 PHR and 50 PHR.

In a detailed aspect of an exemplary embodiment, natural rubber is compounded with epoxy at between 40 PHR and 50 PHR, resulting in the epoxidized top layer that is used to form the EEM layer.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1A is a perspective view of a yoga mat in accordance with the invention, having upper epoxidized elastomeric layer and a lower layer.

FIG. 1B is an exploded view for assembly of the yoga mat of FIG. 1A, depicting a transfer layer having a multicolor image positioned to transfer the image onto the upper epoxidized elastomeric layer.

FIG. 2A is a perspective view of a yoga mat in accordance with the invention, having five layers including a top layer of epoxidized elastomeric material

FIG. 2B is an exploded view for assembly of the yoga mat of FIG. 2A, depicting a transfer layer having a multicolor image positioned to transfer the image onto the top layer of epoxidized elastomeric material.

FIG. 3A is a perspective view of a yoga mat in accordance with the invention, having three layers including a top layer of epoxidized elastomeric material.

FIG. 3B is an exploded view for assembly of the yoga mat of FIG. 3A, depicting a transfer layer having a multicolor image positioned to transfer the image onto the top surface of an epoxidized elastomeric layer.

FIG. 4 is a simplified perspective view of a method for sublimation printing directly onto an epoxidized elastomeric layer.

FIG. 5 is a simplified flow chart for forming a decorated, epoxidized elastomeric layer having a color image.

### DETAILED DESCRIPTION OF THE PREFERRED EMBODIMENTS

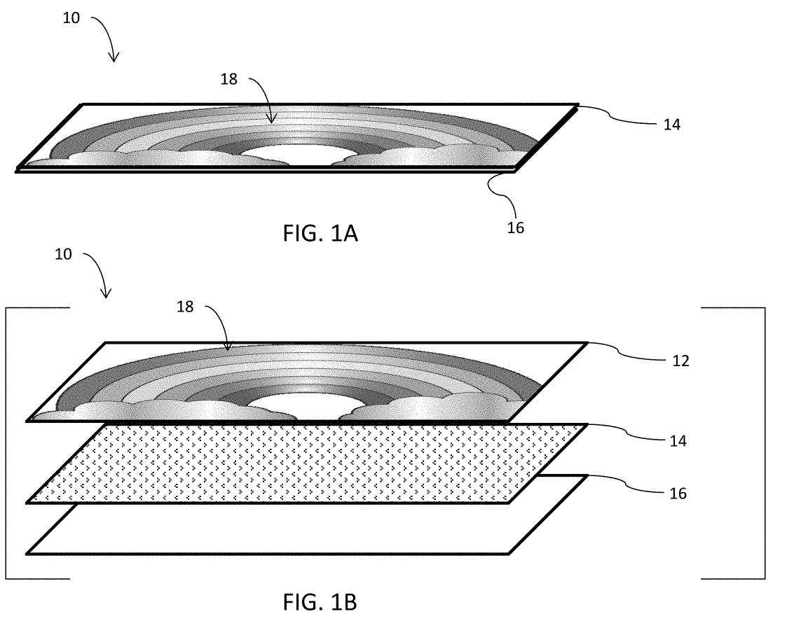

Referring now to the drawings, and particularly FIGS. 1A and 1B, there is shown a yoga mat 10 formed of an epoxidized elastomeric (EEM) layer 14 affixed atop a scrim layer 16. The epoxidized elastomeric layer has a color image 18 retained with high colorfastness and low color migration, resulting in an image capable of retaining sharp detail. In the exemplary embodiment, the image is printed onto the epoxidized elastomeric layer 14 via sublimation utilizing a transfer layer 12 (FIG. 1B), which held the image 18. The scrim layer 16 is attached to the bottom surface of the EEM layer 14. The scrim 16 is formed of non-stretch material, to promote safety.

With continued reference to FIG. 1B, the transfer layer 14 comprises a transfer paper that has the image 18 formed of sublimation dye. Different methods of printing the image on the transfer paper can be used without departing from the invention, including, e.g., silk screen, lithograph, digital printing, ink jet, and rotogravure, among others. Once the image is applied to the transfer paper, the resulting transfer layer is positioned onto the EEM layer to dispose the image thereon. More particularly, the image is sublimated on the EEM layer by applying heat and/or pressure, for prescribed duration(s). As a result of this process, the dye(s) are retained by the EEM layer. In an exemplary embodiment, sublimation of the dye(s)s of the image turn into a gas through an endothermic reaction without passing through the liquid phase.

The EEM layer (14, 24, 44, 55) is configured to be receptive of and to retain color dye(s), e.g., particularly via sublimation. To that end, the EEM layer has an epoxidized elastomeric material, compounded of an elastomer and an epoxy. More particularly, the epoxidized elastomeric material is composed with an elastomer and an effective amount of epoxy, so that resulting EEM layer retain an image having a colorfastness at least 2 (as measured by industry standards for colorfastness, discussed below), multiple color densities, and color migration preferably less than 20 percent. The elastomer can be, e.g., natural rubber, ethylene-vinyl acetate (EVA), thermoplastic elastomers (TPE), polyurethane (PU), nitrile butadiene rubber (NBR), styrene-butadiene rubber (SBR), and polyvinyl chloride (PVC) among others. The epoxy can be pelletized or liquid, among others, of a prescribed amount.

The resultant EEM layer achieves a effective colorfastness, as measured by standardized tests set by the American Association of Textile Chemists and Colorists (AATCC), including colorfastness to crocking (AATCC 8:2013), colorfastness to perspiration (AATCC 15-2013), colorfastness to acids (AATCC 6-2006), and colorfastness to dye transfer in storage (AATCC 163-2013), which are herein incorporated by reference. In an exemplary embodiment, the EEM layer achieves a minimum score of 3 on the aforementioned AATCC tests for colorfastness.

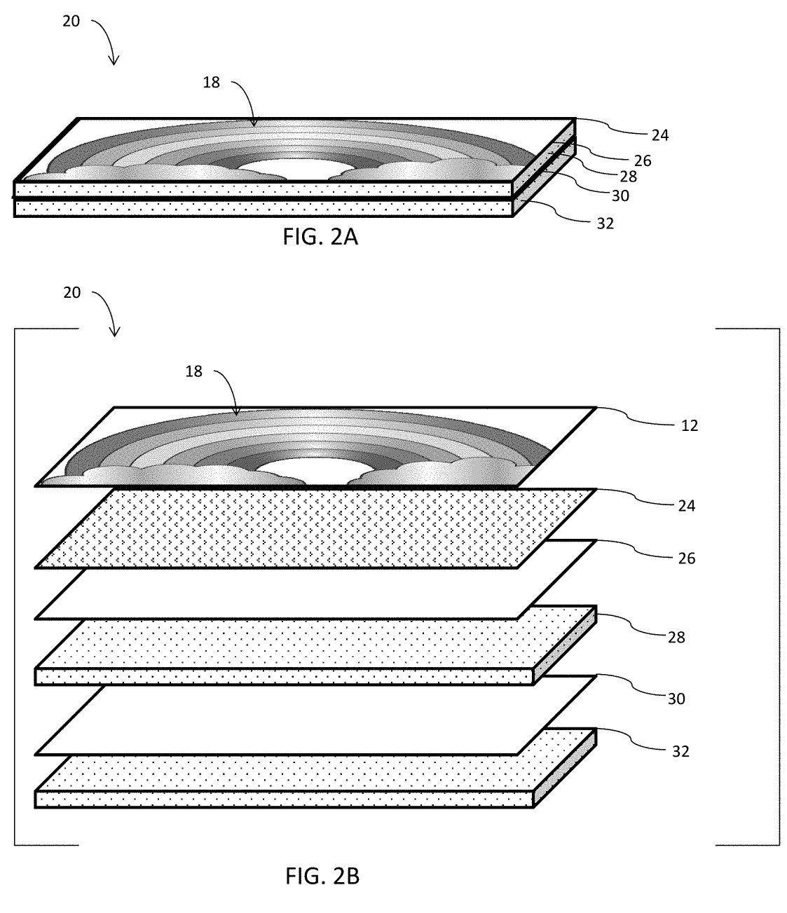

With reference now to FIGS. 2A and 2B, there is shown a yoga mat 20 having a top EEM layer 24 that retains an image 18 formed of sublimation dye. The image 18 is transferred to the top EEM layer 24, via sublimation. This can be achieved via transfer paper 12 as depicted in FIG. 2B or via direct sublimation printing as discussed below. The EEM layer 24 is configured to have sufficient traction tackiness to facilitate user safety. A non-stretch layer, scrim 24, is attached to a bottom surface of the EEM layer, which serves to keep the yoga mat 20 from stretching. A foam layer s 28, 30 and 32 are disposed below the scrim 24, to provide comfort and further facilitates safety. These three foam layers can be configured of various and different materials achieve these desired results.

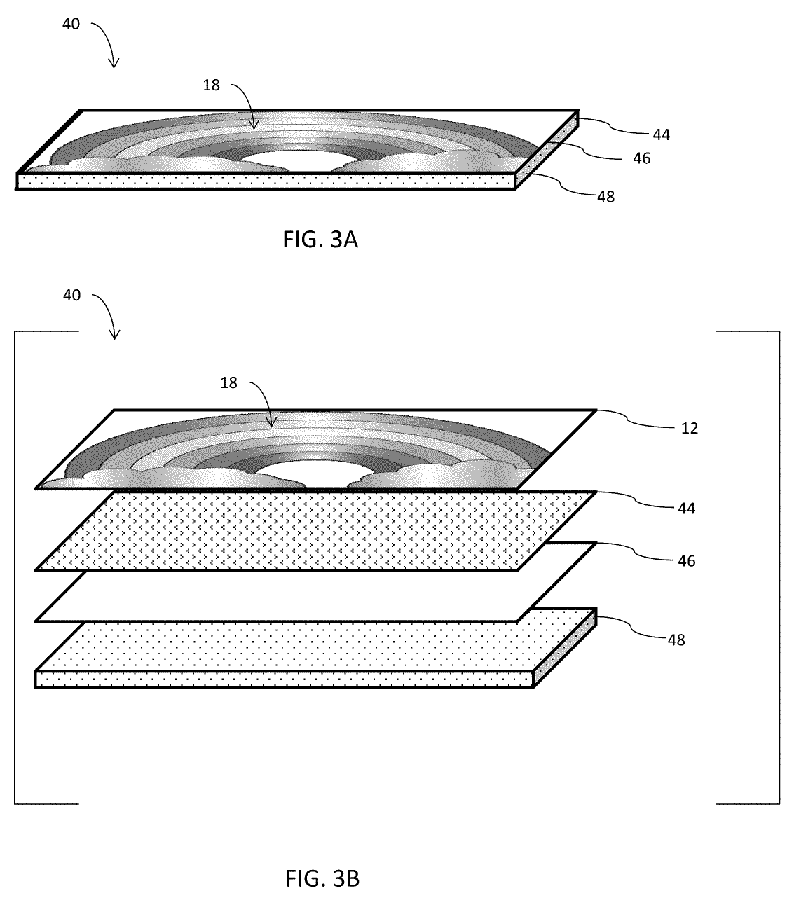

With reference now to FIGS. 3A and 3B, there is shown a yoga mat 40 having three layers, including having a top EEM layer 44 that retains an image 18 formed of sublimation dye. The image 18 is transferred to the top EEM layer 44, via sublimation as discussed herein. The EEM layer 44 is configured to have sufficient traction tackiness to facilitate user safety. A non-stretch layer, scrim 46, is attached to a bottom surface of the EEM layer, which serves to keep the yoga mat 20 from stretching. A foam layer 48 disposed below the scrim, to provide comfort and further facilitates safety. These three foam layers can be configured of various and different materials achieve these desired results. The use of non-wovens and scrims made out of cotton, polyester or other like materials can help differentiate mats and performance attributes.

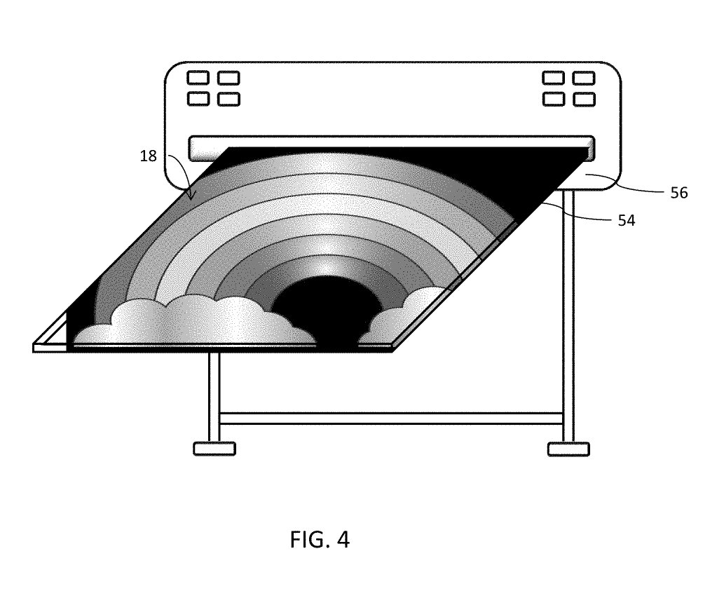

With reference now to FIG. 4, the image 18 can be sublimated directly on to an EEM layer 54 utilizing a sublimation printer 56, rather than utilizing a transfer paper. The sublimation printer utilizes sublimation dye applied to with sufficient heat and pressure. In use a single EEM layer can be processed through the printer. Alternatively, a multilayer article, e.g. yoga mat can be processed through the printer so long as the uppermost surface of the multilayer article comprises an EEM layer. Various sublimation printers are commercially available including from Epson, Inc., Roland DGA Corp., and Mimaki, Inc., among others.

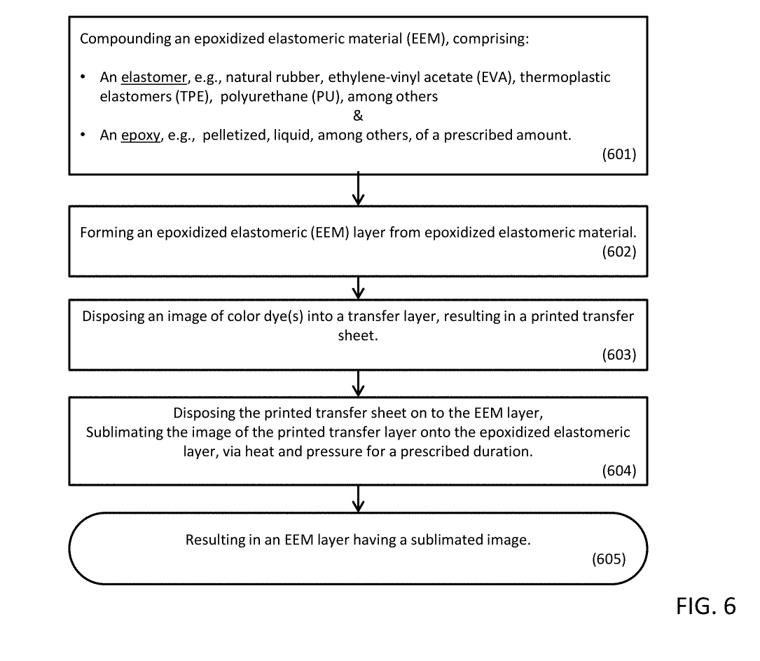

With reference to FIG. 5, the epoxidized elastomeric (EEM) material is formed by compounding an elastomer and an epoxy of a prescribed amount to achieve an EEM layer configured to retain sublimation dye, step 601. More particularly, it has been identified that a minimum of 10 parts per hundred resin/rubber(PHR) of epoxy is needed, and more preferably, compounding with epoxy between 40 PHR and 50 PHR has been found to be particularly effective. The resulting epoxidized elastomeric material is used to form the EEM layer, step 602.

In an exemplary embodiment, a liquid epoxy resin is used, e.g., such as those which are a liquid reaction product of epichlorohydrin and bisphenol A, such as liquid epoxy resin, D.E.R.™ 331 (“DER 331”), a commercially available product from The Dow Chemical Company. The elastomer, natural rubber is compounded with the liquid epoxy at between 40 PHR and 50 PHR, resulting in the epoxidized elastomeric material is used to form the EEM layer. As previously mentioned, the EEM material can comprised various elastomers without departing from the invention, including EVA, TPE, NBR, PU, and/or PVC.

With continued reference to FIG. 6, an image disposed on a transfer paper. resulting in a printed transfer sheet, step 603. More particularly, the image 18 formed of sublimation dye. Different methods of printing the image on the transfer paper can be used without departing from the invention, including, e.g., silk screen, lithograph, digital printing, ink jet, and rotogravure, among others. Next, the printed transfer paper, is positioned onto the EEM layer to dispose the image thereon. More particularly, the image is sublimated on the EEM layer by applying heat and applying pressure, for prescribed duration(s), step 604. In an exemplary embodiment, the following parameters have been used for heat, pressure and time: 390° F. for with applied pressure of 20 lb./in² for 30 seconds.

The EEM layer can be configured for use in a variety of articles that utilize an elastomer layer, which could benefit from depicting a color image retained with high colorfastness and low color migration, resulting in an image capable of retaining sharp detail. For example, articles such sidewalls of tires (e.g., rubber, SBR), sidewalls of shoes (e.g., EVA, natural rubber, SBR), floor mats and puzzle pads (e.g., EVA), and pleather material (e.g., PU, as used in products such as golf gloves, sofas, car seats, among others). For such products, the desired elastomer would be compounded with an effective amount of epoxy to form the EEM material for using in manufacturing the particular product.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

What is claimed is:

1. A method of manufacturing, comprising:
providing an epoxidized elastomeric (EEM) layer configured to retain color dye; and
sublimating an image on a front surface of the EEM layer, in which the resulting image has a colorfastness of at least 2, and color migration of less than 20 percent.

2. The method of claim 1, wherein the sublimating step includes disposing a printed transfer sheet on the front surface of the EEM layer, and sublimating the image of the printed transfer sheet onto the epoxidized elastomeric layer, via application of heat and/or application of pressure.

3. The method of claim 2, wherein the application of heat and/or application of pressure is conducted with a rotary press.

4. The method of claim 2, wherein the application of heat and/or application of pressure is conducted with a vacuum press

5. The method of claim 2, wherein the application of heat and/or application of pressure is conducted with a flat press.

6. The method of claim 1, wherein the sublimating step includes printing sublimation dye directly onto the front surface of the EEM layer.

7. The method of claim 1, wherein the EEM layer is compounded with an elastomer and an epoxy of at least 10 PHR.

8. The method of claim 6, wherein the epoxy is between 40 PHR and 50 PHR.

9. The method of claim 7, wherein the epoxy compounded therein is a liquid epoxy.

10. The method of claim 7, wherein the elastomer is selected from a group consisting of natural rubber, ethylene-vinyl acetate (EVA), thermoplastic elastomers (TPE), polyurethane (PU), Polyvinyl Chloride (PVC), styrene-butadiene, and NBR.

11. The method of claim 7, wherein the elastomer comprises thermoplastic elastomer (TPE).

12. An article of manufacture, comprising:
an epoxidized elastomeric (EEM) layer having a front surface and configured to retain color dye, formed of EEM material compounded with an elastomer and an epoxy of at least 20 PHR; and
a sublimated image formed of sublimation dye on the front surface of the EEM layer, in which the sublimated image has a colorfastness of at least 2, and color migration of less than 20 percent.

13. The article of claim 11, wherein the epoxy is between 10 PHR and 50 PHR.

14. The article of claim 11, comprising a scrim layer coupled to a back surface of the EEM layer.

15. The article of claim 13, in the form of a yoga mat in which the sublimated image is viewable from a top surface of the yoga mat.

16. The yoga mat of claim 14, formed of two layers, namely, (1) the EEM layer having the sublimated image and (2) the scrim attached to the back surface of the EEM layer.

17. The yoga mat of claim 14, formed of three layers, namely, (1) the EEM layer having the sublimated image and (2) the scrim attached to the back surface of the EEM layer, and (3) a foam layer attached to a back surface of the scrim.
